(19) United States
(12) Patent Application Publication
(10) Pub. No.: US 2013/0297442 A1
(43) Pub. Date: Nov. 7, 2013

(54) SYSTEM AND METHOD FOR ROUTING AND TRACKING REAL ESTATE LEADS

(71) Applicant: Realovation Holdings, LLC d/b/a/ Virtual Agent Connect, Salt Lake City, UT (US)

(72) Inventors: Matthew J. Simons, Plymouth, MI (US); Matthew Kent Barrus, West Jordan, UT (US); William Lee Cooper, Cottonwood Heights, UT (US)

(73) Assignee: Realovation Holdings, LLC d/b/a/ Virtual Agent Connect, Salt Lake City, UT (US)

(21) Appl. No.: 13/886,067

(22) Filed: May 2, 2013

Related U.S. Application Data
(60) Provisional application No. 61/641,418, filed on May 2, 2012.

(51) Int. Cl. G06Q 30/02; G06Q 50/16

(52) U.S. Cl. CPC G06Q 30/0201; G06Q 30/0601; G06Q 50/16
USPC 705/26.4

(57) ABSTRACT

Systems, methods, and software for improving communications between real estate professionals and clients or potential clients are provided. The systems and methods are designed to provide improved lead routing and tracking mechanisms, as well as means to provide analysis. The system and method includes a virtual agent communication platform that associates a virtual telephone number to a real estate lead, and manages communication between a real estate agent and the real estate lead. The system and method can further be designed to adjust lead routing decisions and optionally enable tracking of analytics about lead follow up and lead management.

### REFERENCE TO RELATED APPLICATIONS

In accordance with 37 C.F.R. §1.76, a claim of priority is included in an Application Data Sheet filed concurrently herewith. Accordingly, the present invention claims priority under 35 U.S.C. §§119(e), 120, 121, and/or 365(c) to U.S. Provisional Patent Application No. 61/641,418, entitled “SYSTEM AND METHOD FOR ROUTING AND TRACKING REAL ESTATE LEADS”, filed on May 2, 2012. The content of the above referenced application is incorporated herein by reference in its entirety.

### FIELD OF THE INVENTION

The present invention relates to systems and methods related to the real estate field, and more particularly to systems, methods, and software that route and track real estate leads to provide a more efficient manner of serving potential clients.

### BACKGROUND OF THE INVENTION

There are a number of tools that have been developed to assist in real estate transactions. One type of tool is real estate lead routing software that processes and routes real estate “leads”. These systems receive an inquiry from a potential real estate customer, determine where the lead should be routed, and then route the lead to that destination. In this way, a user is serviced promptly when they indicate interest in a real estate transaction on a website or through other marketing, such as by typing a message on a website asking for more information about a real estate listing. In response to entering a message on a website, basic information about the user and the real estate transaction can be sent to lead routing software where it is processed and routed to an appropriate agent.

Although many believe that lead routing software has helped to increase efficiency, and ultimately the number of real estate transactions that are closed, there are some issues with conventional lead routing technology. Notably, it can be difficult to track whether leads are followed up on and ultimately converted.

### SUMMARY OF THE INVENTION

The system includes a virtual agent communication platform that associates a virtual telephone number to a real estate lead, and manages communication between a real estate agent and the real estate lead. Optionally, the system can adjust lead routing decisions and, optionally, the system can enable tracking of analytics about lead follow up and lead.

An identifier is associated with each lead in a database. In one embodiment, the identifier anonymizes the lead's actual telephone number, acts as a key (either alone or in combination with other information) to a database for a lead's actual telephone number, and is or maps to the form of a destination address for a communication protocol.

In one embodiment, the system communicates with the agent to provide the lead with the source address as the identifier. The response is routed through the virtual agent communication platform to the customer. The customer receives the communication with the source as an identifier. A response is routed through the virtual agent communication back to the real estate agent. Future interactions continue the same way. The virtual agent communication platform sitting in between the communications can support enhanced functionality and tracking.

In one embodiment, the present invention includes a method of routing and tracking a real estate lead comprising one or more of the following steps of: providing at least one real estate listing that requires at least one information requesting individual, i.e. a client, potential client, customer or consumer desiring to buy/lease a real estate property) to generate an informational request (i.e. request for a description of listed property, cost, whether or not the property is still available, can the individual purchase the property, or any other inquiry as to the listed property) related to said listing; providing a virtual agent communication platform adapted to provide communication between at least one first information requesting individual and at least one second information providing individual; receiving from at least one information requesting individual a request for information related to said at least one real estate listing; providing at least one virtual identifier; associating said at least one virtual identifier with at least one information requesting individual; routing said information request to at least one information providing individual (i.e. the real estate professional/real estate agent); associating said at least one information providing individual with said at least one virtual identifier; routing a response from said at least one information providing individual to said to at least one information requesting information individual using said at least one virtual identifier, and routing additional communications between said at least one information requesting individual and said at least one information providing individual through said virtual agent communication platform using said virtual identifier.

In an alternative embodiment, the present invention includes a method of routing and tracking a real estate lead comprising one or more of the following steps of: providing a real estate database having at least one real estate listing; providing at least one mechanism to access said database and generate a request for information related to said real estate listing; providing a virtual agent communication platform adapted to provide communication between at least one first information requesting individual and at least one second information providing individual; routing said request for information from said information related to said real estate listing to said virtual agent communication platform at least one first information requesting individual; generating a profile for at least one information requesting individual that has requested information related to said at least one real estate listing; providing at least one first virtual identifier; linking said at least one first virtual identifier to said generated profile; identifying at least one information providing individual; generating a second virtual identifier; linking said second virtual identifier to said at least one information providing individual; routing said information request associated with said at least one information requesting individual to said second virtual identifier; and routing additional communications between said at least one information requesting individual and said at least one information providing individual through said virtual agent communication platform using said first and second virtual identifiers.

In an illustrative embodiment, the present invention includes a non-transitory computer program tangibly embodied in computer instructions in a computer readable medium which, when the computer instructions are executed by a computer, routes and tracks real estate leads by performing one or more acts of: assigning a first virtual identifier to an information requesting individual; assigning a second virtual identifier to an information providing individual; routing communications between said information requesting individual and said information providing individual using said first virtual identifier and said second virtual identifier.

In an illustrative embodiment, the present invention includes a data processing system product comprising a non-transitory computer readable storage medium having computer readable program code embedded therein, the computer readable program code adapted to be executed by a computer to implement a method for routing and tracking real estate leads, the computer readable program code comprising instructions executable to one or more of the following: assign first virtual identifier to an information requesting individual; assign a second virtual identifier to an information providing individual; route communications between said information requesting individual and said information providing individual using said first virtual identifier and said second virtual identifier.

Accordingly, it is an objective of the present invention to teach a system, method, and software which can be used by real estate professionals to enhance customer service.

It is a further objective of the instant invention to teach a system, method, and software which can be used to manage communication between a real estate professional and a client.

It is yet another objective of the present invention to teach a system, method, and software which can be used to route and track real estate leads.

It is a still further objective of the invention to teach a system, method, and software which can be used to analyze interactions and manage communication between a real estate professional and a potential client

It is a further objective of the instant invention to teach a system, method, and software which can be used to analyze average time of an initial lead response, call versus text response times, call detailing reporting including duration and timestamp, text messaging transcripts and timestamps, average number of contact attempts, and the number of leads serviced by the real estate professional agent or real estate professional assistant.

It is a still further objective of the invention to teach a non-transitory computer program tangibly embodied in computer instructions in a computer readable medium which, when the computer instructions are executed by a computer, routes and tracks real estate leads.

It is a still further objective of the invention to teach a data processing system product comprising a non-transitory computer readable storage medium having computer readable program code embedded therein, the computer readable program code adapted to be executed by a computer to implement a method for routing and tracking real estate leads.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 illustrates one embodiment of a system for routing and tracking real estate leads;

FIG. 2 illustrates another embodiment of a system for routing and tracking real estate leads;

FIG. 3 illustrates a screen capture of a text message lead alert to a real estate agent;

FIG. 4 illustrates a screen capture of a customer relationship management interface;

FIG. 5 illustrates one embodiment of a representative screen capture of a text message response to a lead;

FIG. 6A illustrates another embodiment of a representative screen capture of a text message response to a lead;

FIG. 6B is an illustrative embodiment of a screen capture illustrating a running history functionality;

FIG. 7 illustrates a flowchart of a method of routing a lead and follow-up communication between a real estate agent and a lead;

FIG. 8 illustrates a flowchart of a method of routing a lead and follow-up communication between a real estate agent and a lead using real estate agent assigned virtual telephone numbers and lead assigned virtual telephone numbers;

FIG. 9 illustrates a flowchart of a method of routing a lead and follow-up communication between a real estate agent and a lead using one virtual telephone number per lead.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

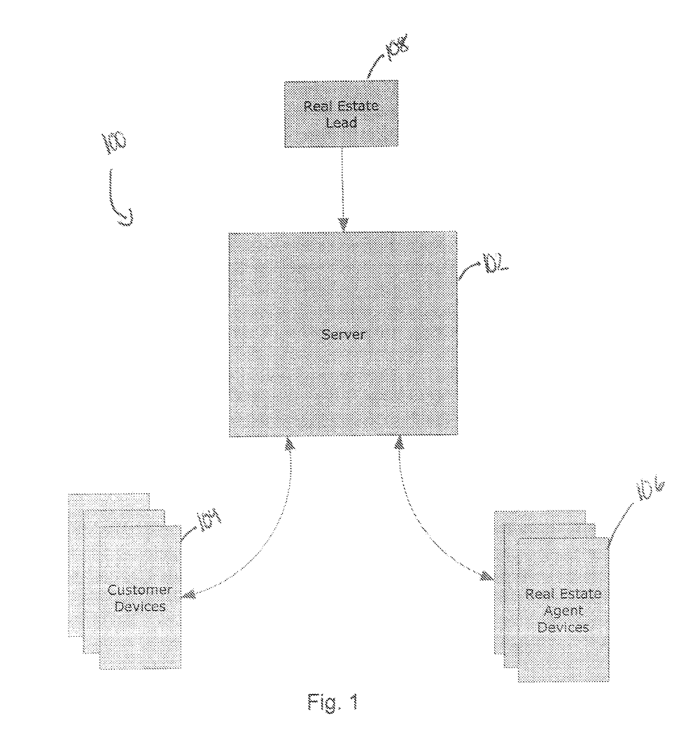

One embodiment of a virtual agent communication system and method for routing and tracking real estate leads is generally illustrated in FIG. 1 and will be discussed in more detail below. When a customer makes a real estate inquiry, a real estate lead can be generated and automatically routed to a real estate agent. At the time the lead is generated, a unique identifier is provisioned and associated to that customer, or combination of customer and real estate agent, in a database. The identifier can be a virtual telephone number such as a traditional long code telephone number or short code telephone number, a virtual email address, or another type of identifier. The system can automatically send information on the property to the customer's cell phone via a text message delivered from a long code or short code associated in the database with the agent. The agent can also receive a notification, such as by text message, of the new lead which is delivered from the customer's newly provisioned long code. Thereafter, communication between customers and real estate agents can be tracked by the system because communication is automatically routed through a virtual agent communication platform.

Throughout the application, reference is made to real estate leads and customers. It should be understood that these terms are used interchangeably and refer to any person attempting to obtain services from a real estate agent or real estate agency. Further, throughout the application, reference is made to real estate agents or real estate agent assistants. It should be understood that these term are being used generally to help provide context for the invention, but that the terms refer to any person that would use the virtual agent communication system to communicate with customers. For example, it is possible that a real estate agent assistant is a real estate agent acting in the capacity as an assistant to help qualify a lead. Alternatively, it is possible that the actions attributed to a real estate agent within the context of the invention are actually performed at a real estate agent's instruction on their behalf.

If a real estate agent responds to a real estate lead provided by the system, the system can automatically log and track how long it took to respond. The system can also log the content of the response. If the real estate agent does not respond to the lead, the system can log and track that. This information can be stored in a database and used by the system to make lead routing decisions during operation or to generate reports for later lead routing rules adjustments. For example, if a real estate agent does not respond to a lead within a certain predetermined time period, a reminder can be sent to the agent or the lead can be routed to a different agent or to a pool of agent assistants that can qualify the lead. In another example, a report can be generated that indicates various metrics, such as the average time for a real estate agent to respond to a lead, which can be used to make adjustments to the system, such as the predetermined time period for reminding an agent or rerouting the lead.

Referring to FIG. 1, one embodiment of the virtual agent communication system includes a server 102, a plurality of customer devices 104, and a plurality of real estate agent devices 106. The server can run virtual agent communication software programmed to receive or generate real estate leads 108, assign identifiers to real estate leads, determine the real estate agents to whom to route the leads, and manage communication between the real estate agents and the leads.

Generating real estate leads is well known and therefore will not be discussed in detail. Suffice it to say that a lead can be generated by a third party system and passed to the virtual agent communication system, or the virtual agent communication system can generate a real estate lead in response to a customer real estate inquiry. For example, if a customer makes an inquiry about a property on a real estate website, the website can be configured to collect information, create a real estate lead, and automatically communicate the real estate lead to the virtual agent communication system. For example a real estate lead could include a customer's name, telephone number, and a real estate comment or question. The website could be part of the virtual agent communication system or a third party system that interfaces with the virtual agent communication system. One example of a third party lead generator is the LeadRouter™ technology owned by Coldwell Banker.

A lead can originate from a variety of locations. For example, a customer can use a web interface on a real estate website to indicate interest in a real estate transaction. A customer can scan an optical machine readable label, such as a bar code or QR code on a real estate sign. A customer can text a keyword to a short code number that is configured to generate a real estate lead. A keyword can essentially be any predefined set of characters that can be recognized by the system and used to trigger generation of a real estate lead. A customer can call a toll free number and trigger generation of a real estate lead, for example by entering a property code, speaking a keyword or speaking a street address. A real estate lead can be generated from essentially any contact with a customer that desires information about a real estate transaction.

In one embodiment, the process for generating a lead or verifying a lead includes completing a lead profile. A lead profile can include a variety of information about the customer that has a real estate related inquiry. For example, in one embodiment the lead profile merely includes a customer's name and a customer's actual telephone number. In another embodiment, a lead profile can include a source identifier (such as a telephone number of the source where the lead originated), the source name (the name of the source where the lead originated), a timestamp of when the lead was generated, a customer identifier (i.e. the name, nickname, or email address provided by the customer), the customer phone number (i.e. customer can provide the telephone number if a fill-in field or the telephone number could be provided by a caller-id functionality), a description of the customer's real estate interest or issue, the consumer's email address, the consumer's mobile telephone, a property identifier, a real estate identifier (i.e. the real estate agent's identifier that is assigned to this lead or the real estate agent's identifier that is assigned to the property of interest), or the lead status. The content of the lead profile can be adjusted depending on the situation and application.

The lead profile information can be stored in a local or remote database. Missing information that is not provided in the initial lead may be looked up or left blank. For example, wireless carrier phone number lookup or a consumer name lookup can provide some information about the customer. Social media can also be used to provide lead profile information. The profile completion step can be automated as part of the process of generating a new lead or in response to receiving a lead from a third party lead provider.

The virtual agent communication system can notify third party applications of any updates to the lead profile or any events that occur in conjunction with the lead. For example, if the lead is assigned to a real estate agent, the virtual number assignments change, or there are text messages, voice calls or emails between the real estate agent and the lead, then the 3rd party application can be notified. This notification can be an automated process between the two applications.

The server, sometimes referred to as a virtual agent communication platform, sits in between communications between the lead, sometimes referred to as the customer, and the agent. When an agent receives a lead from a customer, it is sent, via email or other routes, to the server. The lead can then be scrubbed of all important information such as the property address, consumer name and contact number. New identification can then be associated with the customer. Notification such as a text or telephone call can be sent to the agent identifying the customer using the new identifier. Such action begins the interaction with the client. Text, call, and email transactions can be logged in an effort to provide analytics around lead follow up and conversion.

The analytics can be designed to measure and compare various characteristics, such as but not limited to 1) measuring the average time of the initial lead response, i.e. determining how fast the agent reacts once the lead has been generated, 2) analyzing call versus text response trends, 3) call detail reporting, including duration and time stamp, 4) text messaging transcripts and time stamps, 5) average number of contact attempts, and 6) number of leads serviced by an agent versus the number of leads served by an agent assistant.

The server can be a general purpose computer and may include central processing unit (CPU), a read only memory (ROM), random access memory (RAM), a hard drive (HD) or storage memory, and input/output devices. The software may be implemented in suitable software code that may reside within the RAM, ROM, or HD. The server may also include a dedicated embedded software device, a distributed computer system, or essentially any other computer system capable of managing the communication between real estate agents and leads. In the depicted embodiment, the server includes telephony equipment for handling communication between the customer devices and the real estate devices.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may be comprised of various means including entirely of hardware, entirely of software (including firmware, resident software, micro-code, etc.), or any combination of hardware and software. Furthermore, embodiments of the present invention may take the form of a computer program product including a computer-readable storage medium having computer-readable program instructions (e.g., computer software) embodied in the storage medium, e.g., memory device.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

The one or more computer-executable program code stored in a transitory and/or non-transitory computer-readable medium (e.g., a memory, etc.) directs, instructs, and/or causes a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

In one embodiment, communication, such as calls or text messages, made to the customer phone number on record first are directed to the virtual agent communication platform. This can be accomplished by providing the customer's virtual telephone number to the agent with the lead so that the agent's sole contact with the lead is via the customer's virtual telephone number. When the virtual agent communication platform receives a call from the customer's virtual telephone number, the virtual agent communication platform can look up the actual telephone number of the customer and outdial or text message the consumer from the agent's virtual number. The virtual agent communication platform can stay engaged during voice calls to provide call analytics. Text message conversations can be automatically logged so the agent can view a history of communication with the customer.

The customer devices can include a variety of different devices including mobile telephones, tablets, laptop computers, desktop computers, or essentially any device that can be used to communicate with a real estate agent. Similarly, the real estate agent devices can also include the same types of devices.

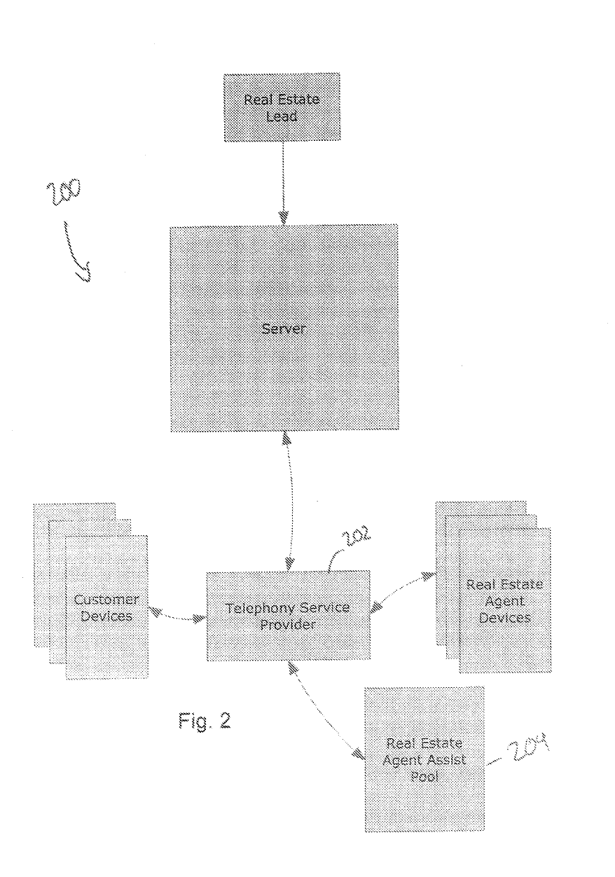

Referring to FIG. 2, an alternative embodiment of a virtual agent communication system 200 is illustrated. This embodiment is similar to the FIG. 1 system except that a third party telephony service provider 202 manages the communication between the agents and customers in response to instructions from the virtual agent communication platform. In addition, the FIG. 2 embodiment includes an agent assist pool 204 where leads can be routed in certain circumstances. For example, if a lead is routed to a real estate agent and the real estate agent does not respond within a predetermined time period, the lead may be re-routed to the agent assistant pool where an assistant can qualify the lead before the real estate agent takes the lead back and closes it. In one embodiment, the agent assistant pool includes other real estate agents, a call center, or both. Although the agent assistant pool feature and the third party telephone provider features are shown in connection with FIG. 2, it should be understood that these features can be implemented in other embodiments in combination with features from other embodiments, including for example the embodiment illustrated in FIG. 1. That is, the embodiment of FIG. 1 may include an agent assist pool and associated processes to route leads there. Further, FIG. 1 may include both internal telephony equipment for routing, as well as the ability to interact with a third party telephony service provider as shown in FIG. 2.

In order to enact use of the virtual agent communication platform, the platform can include an agent assist module that includes programming that reassigns leads to an assistant agent for qualification and then provides the ability for the lead to be assigned back to the original agent on record for that lead once the lead has been qualified. The agent of record can have the ability to view leads that are being serviced by the agent assist group and can request to take back a lead at any time. In one embodiment, the agent assist module can be configured to communicate with the agent that there will be a referral fee charge on any closed transactions associated with a lead handled by the agent assist group, payable to the real estate company. In some embodiments, real estate agents are not charged a referral fee. In one embodiment, instead of charging a referral fee, a real estate company that employs the real estate agents utilizing the virtual agent communication platform can collect a fee and a separate pricing model can be negotiated with the real estate company. That is, in some embodiments, the virtual agent communication platform and its various services are not sold directly to agents, but instead to real estate organizations (brokerages, franchises, etc.).

Qualifying the lead generally refers to obtaining additional information about the lead, typically by calling the customer and soliciting answers to questions. This enables the customer to quickly receive feedback regarding their inquiry and also enables the strength of the lead to be assessed before the real estate agent decides to handle the lead. For example, an assistant may call a customer and attempt to determine whether the customer intends to purchase a property within the next 90 days or whether they are casually looking at properties while on vacation.

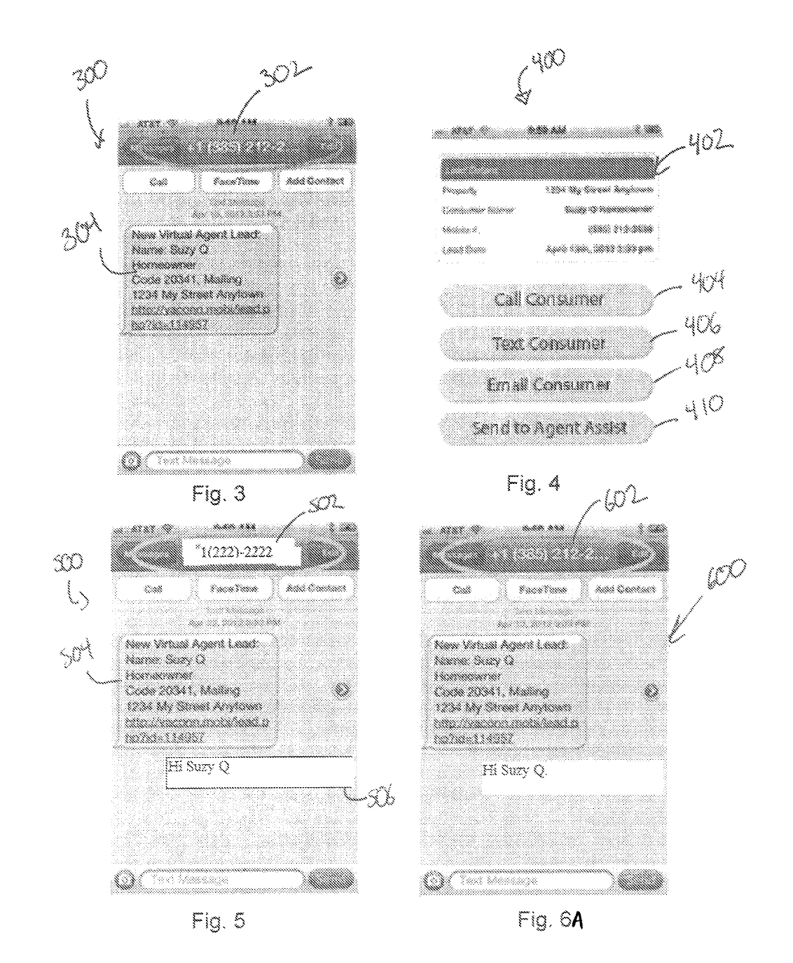

FIG. 3 illustrates a screen capture 300 of a communication from one embodiment of a virtual agent communication system to an agent's mobile device. The screen capture 300 includes a text message containing a real estate lead routed by the virtual agent communication platform. The screen capture illustrates that the source of the text message is from the customer's virtual telephone number 302. The text message content 304 includes information about the new virtual agent communication lead including the customer's name, the property of interest and a link to a customer relationship management interface.

FIG. 4 illustrates a screen capture 400 of one embodiment of a customer relationship management interface. The interface includes details about the lead 402, such as the property of interest, the customer's name, the customer's virtual telephone number, and the date and time that the lead was received. The interface also provides the real estate agent with four options: call consumer 404, text consumer 406, email consumer 408, and send to agent assist 410. The call customer option will initiate a call to the customer's virtual telephone number that was assigned in the virtual agent communication system at the time the lead was initialized. Similarly, the text customer option will initiate a text message to the customer's virtual telephone number that was assigned in the virtual agent communication system at the time the lead was initialized. Email customer will initiate an email message to a virtual email address handled by the virtual agent communication system. Send to agent assist will reroute the lead to an agent assistant pool that will qualify the lead so that the real estate agent can handle the lead later. Accordingly, clicking the call or text button routes the communication between the agent and lead through the identifier so that the details, such as the body of the text or time of call can be tracked and organized with the lead information.

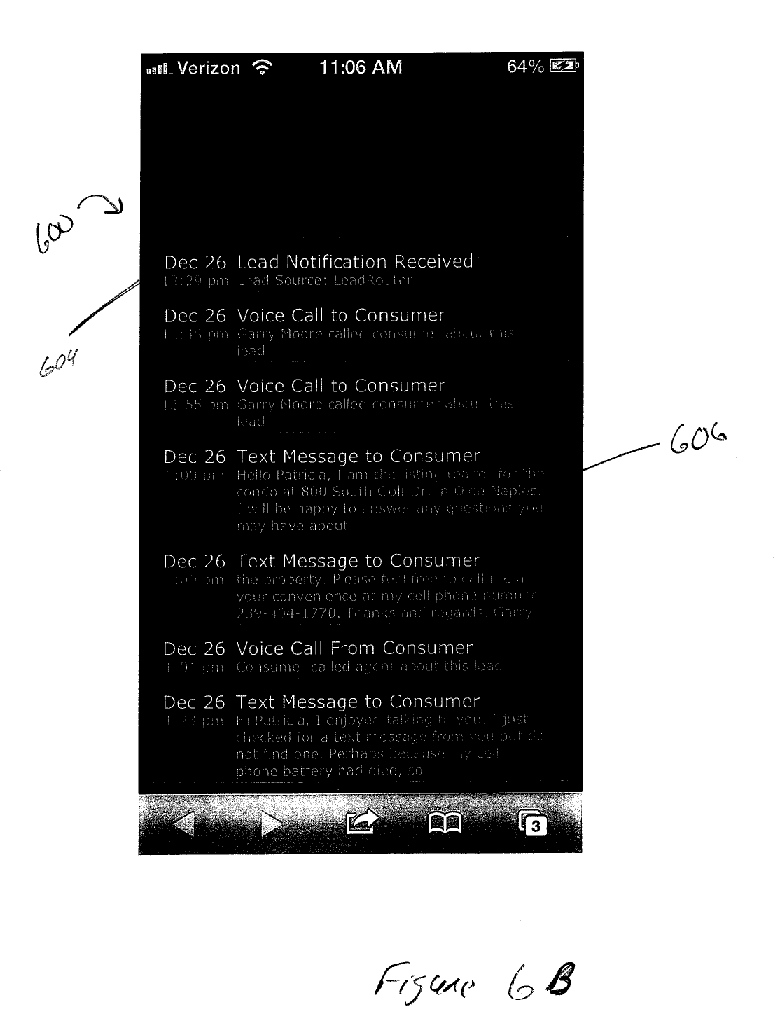

FIG. 5 illustrates a screen capture 500 of a communication from one embodiment of a virtual agent communication system to a customer's mobile device. The screen capture 500 includes a response to a real estate lead. The screen capture illustrates that the source of the text message is from the agent's virtual telephone number 502. The text message content 504, 506 includes information about the inquiry and the agent's response. In an alternative embodiment, the original agent's response to the lead text may be removed before being sent to the customer.

FIG. 6A illustrates a screen capture 600 of a communication from another embodiment of a virtual agent communication system to a customer's mobile device. This screen capture is identical to the FIG. 5 screen capture except that the source virtual telephone number 602 is the same as the source virtual telephone number that was provided to the agent. In this embodiment, instead of each real estate agent and each lead being assigned a unique virtual telephone number, each real estate agent and lead combination is assigned a unique virtual telephone number. The virtual agent communication system can determine where to route communication by looking up the destination address based on the responses destination, which will always be the virtual telephone number, and the source address accompanying the response.

Referring to FIG. 6B, an alternative screen capture 600 is shown. As shown, the screen capture illustrates a running history function in which all reactions related to the lead are recorded and visible as a “running history.” The running history includes communications, either from multiple entries from a single client or multiple clients. The running history can include date stamp 604, text messages transcripts 606. The running history may also include, but not limited to duration of call, call details, number of contact attempts, or whether the call was handled by the agent or his/her assistant.

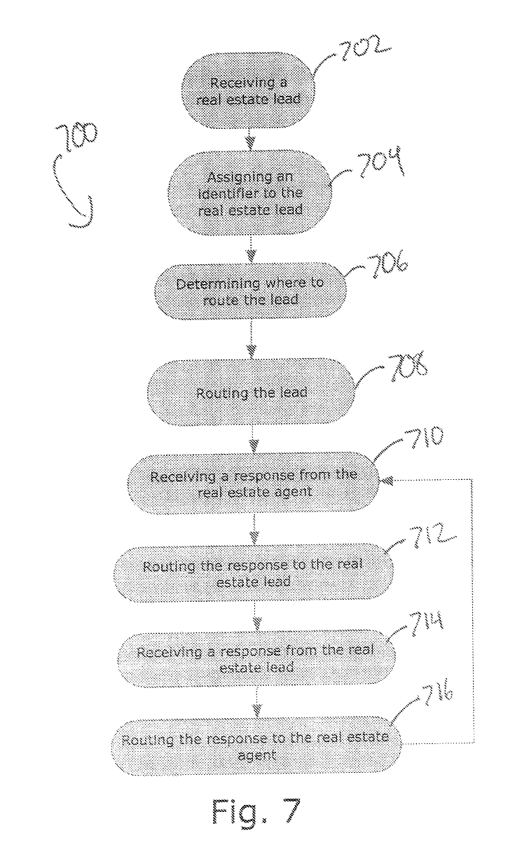

FIG. 7 illustrates a flow chart of one embodiment of a method for routing and tracking real estate leads 700. The method includes receiving a real estate lead 702. As mentioned above, receiving a real estate lead can include receiving information from a potential real estate services customer and generating a real estate lead or it can include receiving a real estate lead from a lead generator.

The method further includes assigning an identifier to the real estate lead 704. The identifier can be a virtual telephone number (short code or long code), a virtual email address or another type of identifier that can be utilized to uniquely identify the lead. Assigning an identifier can include engaging a third party provisioning service provider that provisions virtual telephone numbers. One example of a service provider or provisioner is Syniverse.

The method further includes determining where to route the lead 706. Essentially, any process for determining where to route the lead can be used. For example, leads could be systematically routed one by one to each agent in a pool of agents. The leads can be simultaneously routed to multiple agents so that, whichever agent responds first disables the ability for another agent to act on the lead. Determining where to route the lead can be based on a rules engine that accounts for a variety of factors. For example, if the lead includes property information, the lead can be routed to the listing agent on the property. If the lead was previously routed and was not responded to, the lead may be routed to an agent assistant pool of agents or to a different agent than the listing agent.

The method further includes routing the lead 708. Depending on the destination and method of communication routing, the lead can take a variety of different forms. For example, if the lead is being routed via text message, then routing the lead can include preparing and routing a short message service message, which is a standardized communication protocol for text messages. Routing the lead can also include providing instructions to a third party routing service. For example, a cloud communication client such as Twilio™ has an application programming interface that can use Markup such as VoiceXML or another protocol to communicate with Twilio and provide instructions for routing the lead and for ensuring that the communication comes from the appropriate source.

The process of routing the lead can include routing an initial message to the customer. For example, if the customer logs into a website and makes a real estate inquiry about a property, thereby generating a real estate lead that makes its way to the virtual agent communication system. One step in routing that lead to a real estate agent for closing may be to send a text message to the customer's mobile telephone indicating that the lead was received and that a real estate agent will contact them. The communication to the customer can include the source telephone number as the selected real estate agent's virtual number. In this way, the customer could initiate a text message directly to the listing agent through the virtual agent communication platform. If a response to that text message was not delivered by the agent in a predetermined time period, then the lead, including the new text message, can be routed to a different real estate agent or to an assistant.

The method includes receiving a response from the real estate agent. The virtual agent communication platform receives the response because the communication to the real estate agent included a source virtual telephone number that both identifies the customer and is a provisioned virtual telephone number that routes to the virtual agent communication platform (or a third party service provider that communicates with and takes instruction from the virtual agent communication platform). At this point, a timestamp and content from the communication can be logged in a database for use by the agent later or for use in various analytics.

The method includes routing the response to the real estate lead 714. This is a similar process to routing the lead initially, except that the destination is the customer's actual telephone number, which was provided (or looked up) in the initial real estate lead. In one embodiment, the response has a source address as the real estate agent's virtual telephone number. In an alternative embodiment, the response has a source address as the virtual telephone number associated with the combination of real estate agent and customer.

The method includes rerouting the response from the lead back to the real estate agent 716. Because the lead is responding to a message with a virtual telephone number source address, the message will be routed through the virtual agent communication platform where the real estate agent's actual telephone number can be looked up and the communication can be routed to the real estate agent. This process of communication between the real estate agent and lead can be repeated over and over. For purposes of analytics and logging, the system can be configured to manage a certain predetermined number of exchanges between the lead and the agent. Alternatively, the virtual agent communication involvement may be capped based on the amount of time since the lead originated.

The virtual telephone number can be disassociated from a lead or from a lead and real estate agent combination. The process of disassociating the virtual telephone number can allow that virtual telephone number to be reused for a new lead or lead and real estate agent combination. This can result in cost savings because there is a cost associated with provisioning telephone numbers for use in the system. The disassociation process can include providing a message to the customer and real estate agent that includes the other party's actual telephone number. By providing a communication with the source having the actual telephone number, the virtual agent communication platform can be cut out of the loop from future communication.

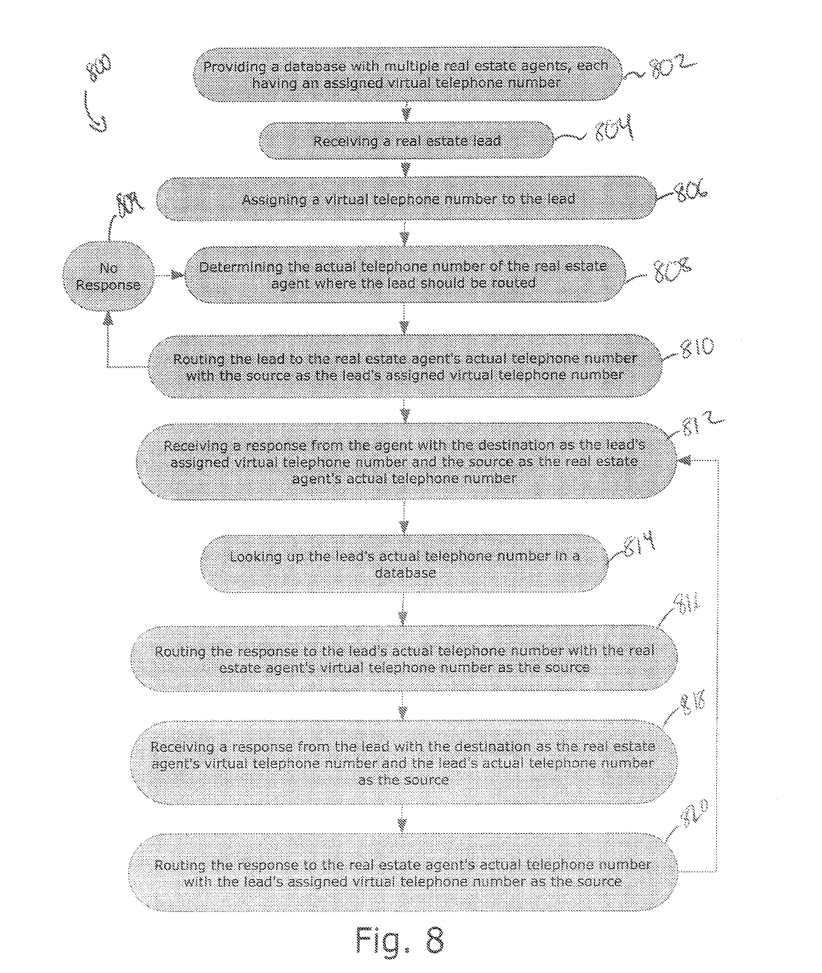

Referring to FIG. 8, another embodiment of a method for routing and tracking real estate leads 800 is provided. The method includes providing a database with multiple real estate agents, each having an assigned virtual telephone number 802, receiving a real estate lead 804, assigning a virtual telephone number to the lead 806, determining the actual telephone number of the real estate agent where the lead should be routed 808, routing the lead to the real estate agent's actual telephone number with the source as the lead's assigned virtual telephone number 810, if no response is received 809 then determining the actual telephone number of the real estate agent where the lead should be routed 808, which may be a different real estate agent or may be a real estate assistant, or receiving a response from the agent with the destination as the lead's assigned virtual telephone number and the source as the real estate agent's actual telephone number 812, looking up the lead's actual telephone number in a database 814, routing the response to the lead's actual telephone number with the real estate agent's virtual telephone number as the source 816, receiving a response from the lead with the destination as the real estate agent's virtual telephone number and the lead's actual telephone number as the source 818, routing the response to the real estate agent's actual telephone number with the lead's assigned virtual telephone number as the source 820. This process of communication between the real estate agent and lead can be repeated.

By providing a separate virtual telephone number for each real estate agent, the real estate agent can use the virtual telephone number. For example, virtual telephone numbers can be publicly marketed by real estate agents and combined with additional virtual agent communication system services (such as automated call management, call routing, voice mail to text, automated showing services and more). For example, the virtual telephone number can be provided on the real estate agent's business card so that communication to that agent is routed through the virtual agent communication platform.

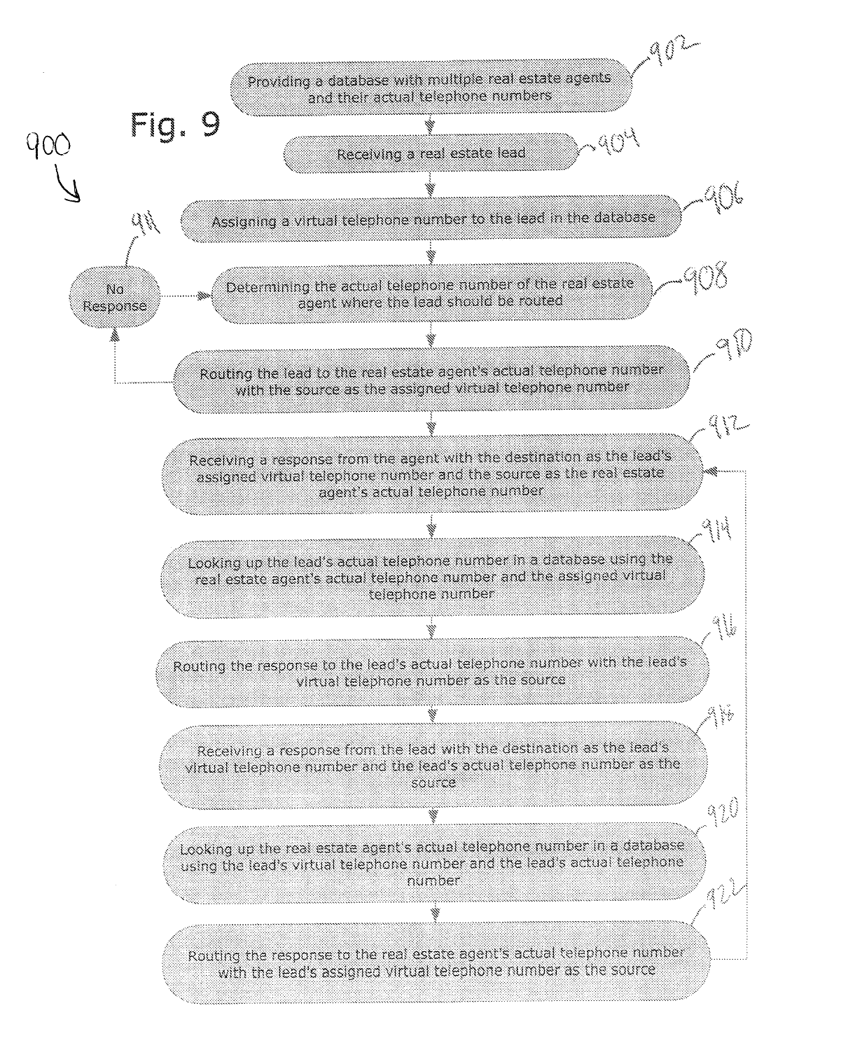

Referring to FIG. 9, another embodiment of a method for routing and tracking real estate leads 900 is provided. The method is similar to the method described in FIG. 8, except that, instead of each real estate agent and each lead having a virtual telephone number, each combination of lead and real estate agent has a virtual telephone number assigned. The method includes providing a database with multiple real estate agents and their actual telephone numbers 902, receiving a real estate lead 904, assigning a virtual telephone number to the lead in the database 906, determining the actual telephone number of the real estate agent where the lead should be routed 908, routing the lead to the real estate agent's actual telephone number with the source as the assigned virtual telephone number 910, if no response is received 911 then determining the actual telephone number of the real estate agent where the lead should be routed, which can be different from the first time depending on a variety of criteria, such as the time elapsed since receiving the lead, or receiving a response from the agent with the destination as the lead's assigned virtual telephone number and the source as the real estate agent's actual telephone number 912, looking up the lead's actual telephone number in a database using the real estate agent's actual telephone number and the assigned virtual telephone number 914, routing the response to the lead's actual telephone number with the lead's virtual telephone number as the source 916, receiving a response from the lead with the destination as the lead's virtual telephone number and the lead's actual telephone number as the source 918, looking up the real estate agent's actual telephone number in a database using the lead's virtual telephone number and the lead's actual telephone number 920, and routing the response to the real estate agent's actual telephone number with the lead's assigned virtual telephone number as the source 922. This process of communication between the real estate agent and lead can be repeated.

When a customer calls an interactive voice response system for a real estate related inquiry, such as information about a property, or texts a property code to a short code, a real estate lead is generated and routed to a real estate agent. At the time the lead is generated, a long code can be provisioned and associated to that customer relationship in a database. The customer may automatically receive information on the property back to their cell phone via a text message delivered from the agent's long code. The agent receives notification, such as a text message, of the new lead which is delivered from the new long code. In the event the agent has already interacted with this specific client and a long code has already been provisioned to this relationship, it can be used repeatedly for future interactions.

All future interactions between the client and the consumer can go through this pair of long codes, with the virtual agent communication platform sitting in between all communications to support enhanced functionality and tracking. The client may text or call the long code tied to the consumer, at which point the system can look up relevant information for the transaction such as the client ID, consumer ID, and property lead in question, and associate the call/text message with the lead so it may be tracked inside a database and the client's back office website. The consumer may also call or text the client's long code and details can be tracked in the same manner.

As discussed above, but discussed in more detail herein, the long code created for the consumer can be shared among multiple consumers. When there is an interaction with this consumer long code, the real estate agent's long code on the other end of the interaction can be looked up to determine the ID of the real estate agent/consumer relationship. For example, if three real estate agents each have their own unique long codes, A, B, and C, and three long codes are reserved for customers, X, Y, and Z, multiple interactions can be tracked between the pairs of long codes, such as:

A&X=1

A&Y=2

A&Z=3

B&X=4

B&Y=5

Because the real estate agent retains the same long code, their code is not shared among other real estate agents. That is, the long codes are unique among real estate agents. Therefore, any texts or calls to that long code can be routed back to the telephone number on file for that real estate agent.

It is possible to reduce the number of long codes the system assigns at any given time. In one embodiment, customer long codes may be expired after a certain amount of time passes with no activity. For example, if a customer and client tied to relationship 1 (A & X) stop interacting, that relationship can be expired so the next new customer that interacts with real estate agent A can be assigned long code X.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of routing and tracking a real estate lead comprising the steps of:
providing at least one real estate listing that requires at least one information requesting individual to generate an informational request related to said listing;
providing a virtual agent communication platform adapted to provide communication between at least one first information requesting individual and at least one second information providing individual;
receiving from at least one information requesting individual a request for information related to said at least one real estate listing;
providing at least one virtual identifier;
associating said at least one virtual identifier with at least one information requesting individual; and
routing said information request to at least one information providing individual.

2. The method of routing and tracking a real estate lead according to claim 2 further including the step of associating said at least one information providing individual with said at least one virtual identifier; and routing a response from said at least one information providing individual to said to at least one information requesting information individual using said at least one virtual identifier.

3. The method of routing and tracking a real estate lead according to claim 2 further including the step of routing additional communications between said at least one information requesting individual and said at least one information providing individual through said virtual agent communication platform using said virtual identifier.

4. The method of routing and tracking a real estate lead according to claim 1 further including the step of generating a profile for at least one information requesting individual which requests information related to said transaction; and linking said generated profile to said first virtual identifier.

5. The method of routing and tracking a lead generating event according to claim 1 further including the step of providing a second virtual identifier; and linking said second virtual identifier to said at least one information providing individual, whereby each of said at least one information requesting individual and said at least one information providing individual communicate using said first and second virtual identifiers.

6. The method of routing and tracking a real estate lead according to claim 1 further including the step of tracking communications between said at least one information requesting individual and said at least one information providing individual.

7. The method of routing and tracking a real estate lead according to claim 1 further including the steps of providing a plurality of information requesting individuals; providing each said plurality of information requesting individuals with an individual virtual identifier, whereby communication between each said plurality of information requesting individuals is accomplished by using said individual virtual identifiers.

8. The method of routing and tracking a real estate lead according to claim 7 further including the steps of providing a plurality of information requesting individuals; providing each said plurality of information requesting individuals with an individual virtual identifier whereby communication between each said plurality of information requesting individuals is accomplished by using each said individual virtual identifiers and said second virtual identifier.

9. A method of routing and tracking a real estate lead comprising the steps of:
providing a real estate database having at least one real estate listing;
providing at least one mechanism to access said database and generate a request for information related to said real estate listing;
providing a virtual agent communication platform adapted to provide communication between at least one first information requesting individual and at least one second information providing individual;
routing said request for information from said information related to said real estate listing to said virtual agent communication platform at least one first information requesting individual;
generating a profile for at least one information requesting individual that has requested information related to said at least one real estate listing;
providing at least one first virtual identifier;
linking said at least one first virtual identifier to said generated profile;
identifying at least one information providing individual;
generating a second virtual identifier;
linking said second virtual identifier to said at least one information providing individual;
routing said information request associated with said at least one information requesting individual to a said second virtual identifier.

10. The method of routing and tracking a real estate lead according to claim 9 further including the step of routing additional communications between said at least one information requesting individual and said at least one information providing individual through said virtual agent communication platform using said first and second virtual identifiers.

11. The method of routing and tracking a real estate lead according to claim 9 wherein said first or second virtual identifier is a long code telephone number or a short code telephone number.

12. The method of routing and tracking a real estate lead according to claim 9 wherein said first or second virtual identifier is a virtual email address.

13. The method of routing and tracking a lead generating event according to claim 11 further including the step of tracking all communications between at least one information requesting individual and said at least one information providing individual.

14. The method of routing and tracking a lead generating event according to claim 13 further including the step of analyzing said tracked data.

15. The method of routing and tracking a lead generating event according to claim 9 further including the step of rerouting said lead to a second information providing individual after a predetermined time period in which said first information providing individual does not act on said lead.

16. The method of routing and tracking a lead generating event according to claim 9 further including the step of linking said virtual agent communication platform to a third party; and routing at least one communication between individuals through said third party.

17. The method of routing and tracking a real estate lead according to claim 9 wherein said mechanism to request information includes use of a written advertisement, a video advertisement, a website, a telephone number, text messaging, optical machine readable labels, or combinations thereof.

18. A non-transitory computer program tangibly embodied in computer instructions in a computer readable medium which, when the computer instructions are executed by a computer, routes and tracks real estate leads by performing the acts of:
assigning a first virtual identifier to an information requesting individual;
assigning a second virtual identifier to an information providing individual;
routing communications between said information requesting individual and said information providing individual using said first virtual identifier and said second virtual identifier.

19. A data processing system product comprising a non-transitory computer readable storage medium having computer readable program code embedded therein, the computer readable program code adapted to be executed by a computer to implement a method for routing and tracking real estate leads, the computer readable program code comprising instructions executable to:
assign first virtual identifier to an information requesting individual;
assign a second virtual identifier to an information providing individual;
route communications between said information requesting individual and said information providing individual using said first virtual identifier and said second virtual identifier.
